(19) United States
(12) Patent Application Publication
(10) Pub. No.: US 2026/0080296 A1
(43) Pub. Date: Mar. 19, 2026

(54) SYSTEMS AND METHODS TO EXTRACT SEMANTIC INFORMATION FROM DOCUMENTS

(71) Applicant: Instabase, Inc., Dover, DE (US)

(72) Inventors: Vineeth Chinmaya Murthy, Bengaluru (IN); Hariharan Thirugnanam, Bengaluru (IN)

(21) Appl. No.: 18/161,621

(22) Filed: Jan. 30, 2023

(51) Int. Cl. G06N 20/00

(52) U.S. Cl. CPC G06N 20/00

(57) ABSTRACT

Systems and methods to extract semantic information from documents are disclosed. Exemplary implementations may obtain target-specific aggregated embeddings representing generalized semantic contexts of sequences of text included in segments pertinent to targets and a set of sequences of text included in segments included in a document; provide the set of sequences of text as input for a retriever model configured to take as input sequences of text and to output embeddings representing semantic meanings of the sequences of text; obtain output embeddings from the retriever model, generate a set of targeted sequences of text in accordance with the output embeddings, provide the set of targeted sequences of text as input for an extraction model configured to take as input sequences of text and output semantic information extracted from the document; and obtain output semantic information from the extraction model.

### FIELD OF THE DISCLOSURE

The present disclosure relates to using machine learning to extract semantic information from documents.

### BACKGROUND

Long documents may use text to convey information, such as legal information. Different types of automated content extraction of electronic documents may be known. Training models to extract content from electronic documents may be known, for example as used in machine learning and/or natural language processing.

### SUMMARY

By virtue of the systems and methods described herein, the process of extracting information from long documents is improved by reducing the amount of information that is processed by a particular machine learning model for information extraction, or an extraction model. Specifically, certain segments of large documents may be determined to be more likely to include useful information than others. The particular machine learning model may process only a portion or selection of the segments in a large document. Specifically, the particular machine learning model may process a subset of the segments of a large document that are determined to be most likely to include useful information.

One or more aspects of the present disclosure may relate to training a model to extract semantic information from documents. Individual ones of the documents may include one or more segments. An individual segment may include a sequence of text. The sequence of text may include one or more character strings arranged in a particular order. Training a model to extract semantic information from documents may include a system configured to extract semantic information from documents. The system may include non-transitory electronic storage media. The non-transitory electronic storage media may be configured to store training information. The training information may include training documents and target labels. An individual training document may include one or more training segments. Individual target labels may indicate individual training segments that are pertinent to individual targets. An individual target may include one or more character strings expressing particular information to be extracted from documents. By way of non-limiting example, the training information may include a first training document and a first target label. The first training document may include a first training segment. The first training segment may be pertinent to a first target. The first target label may indicate the first training segment.

The system may be configured to obtain individual sequences of text included in individual segments. By way of non-limiting example, a first sequence of text included in the first training segment may be obtained. The system may be configured to obtain labelled segments. The labelled segments may be indicated by one or more target labels. The labelled segments may comprise a subset of the training segments. The system may be configured to provide the sequences of text included in the labelled segments as input to a retriever model. The retriever model may be a trained model. The retriever model may be configured to take as input individual sequences of text. The retriever model may be configured to output embeddings representing semantic meanings of the individual sequences of text. The system may be configured to obtain the output embeddings from the retriever model. Individual ones of the output embeddings may individually represent semantic meanings of one or more sequences of text included in the labelled segments. By way of non-limiting example, a first output embedding may represent semantic meaning of the first sequence of text. The first output embedding may be associated with the first target by virtue of the first training segment being pertinent to the first target.

The system may be configured to aggregate the output embeddings associated with individual targets to determine target-specific aggregated embeddings. By way of non-limiting example, output embeddings that are associated with the first target may be aggregated to determine a first target-specific aggregated embedding. The target-specific aggregated embeddings may represent a generalized semantic context of sequences of text included in segments pertinent to the individual targets.

The system may be configured to train an extraction model configured to extract semantic information from documents. The extraction model may take as input the individual sequences of text. The extraction model may output semantic information. The semantic information may be associated with one or more targets. The semantic information may be extracted from the individual sequences of text. Training the extraction model may include determining association of the semantic information with the one or more targets to determine a loss. Training the extraction model may include adjusting weights controlling operations of the extraction model based on a backpropagation of the loss.

One or more aspects of the present disclosure may relate to extracting semantic information from documents. Individual ones of the documents may include one or more segments. An individual segment may include a sequence of text. The sequence of text may include one or more character strings arranged in a particular order. Extracting semantic information from documents may include using a system configured to extract semantic information from documents. The system may be configured to obtain target-specific aggregated embeddings. An individual target-specific aggregated embedding may represent a generalized semantic context of sequences of text included in segments pertinent to an individual target. An individual target may include one or more character strings expressing particular information to be extracted from documents. The target-specific aggregated embeddings may be generated during training of an extraction model. The system may be configured to obtain a document. The document may include a set of segments. Individual segments included in the set of segments may include individual sequences of text. By way of non-limiting example, the set of segments may include a first segment. The first segment may include a first sequence of text. The system may be configured to obtain a set of individual sequences of text included in individual segments included in the set of segments. The system may be configured to provide the set of individual sequences of text as input for a retriever model. The retriever model may be a trained machine learning model. The retriever model may be configured to take as input individual sequences of text. The retriever model may be configured to output embeddings representing semantic meanings of the individual sequences of text. The system may be configured to obtain the output embeddings from the retriever model. By way of non-limiting example, a first output embedding may be obtained. The first output embedding may represent semantic meaning of the first sequence of text.

The system may be configured to generate a set of targeted sequences of text. The set of targeted sequences of text may include individual sequences of text represented by individual ones of the output embeddings. The set of targeted sequences of text may be a subset of the set of individual sequences of text. By way of non-limiting example, the set of targeted sequences of text may include the first sequence of text by virtue of the first segment being pertinent to a first target. Generating the set of targeted sequences of text may include generating similarity values associated with individual ones of the output embeddings. Generating the similarity values may include measuring similarity between individual ones of the output embeddings and individual ones of the target-specific aggregated embeddings. Individual similarity values may denote individual levels of similarity between individual ones of the output embeddings and individual ones of the target-specific aggregated embeddings. Generating the set of targeted sequences of text may include identifying one or more of the output embeddings as targeted embeddings in accordance with the similarity values. Individual target embeddings may be associated with individual similarity values denoting levels of similarity between the individual target embeddings and individual ones of the target-specific aggregated embeddings above a given threshold. Generating the set of targeted sequences of text may include identifying sequences of text represented by targeted embeddings as targeted sequences of text. Generating the set of targeted sequences of text may include including the targeted sequences of text in the set of targeted sequences of text.

The system may be configured to provide the set of targeted sequences of text as input for the extraction model. The extraction model may have been trained. The extraction model may be configured to extract semantic information from documents. The extraction model may be configured to take as input individual sequences of text. The extraction model may be configured to output semantic information. The semantic information may be extracted from the individual sequences of text. The system may be configured to obtain the output semantic information from the extraction model.

As used herein, any association (or relation, or reflection, or indication, or correspondency) involving servers, processors, client computing platforms, models, documents, values, feature values, vectors, embeddings, pages, segments, sequences, sequences of text, captions, presentations, obtained information, user interfaces, targets, target labels, and/or another entity or object that interacts with any part of the system and/or plays a part in the operation of the system, may be a one-to-one association, a one-to-many association, a many-to-one association, and/or a many-to-many association or “N”-to-“M” association (note that “N” and “M” may be different numbers greater than 1).

As used herein, the term “obtain” (and derivatives thereof) may include active and/or passive retrieval, determination, derivation, transfer, upload, download, submission, and/or exchange of information, and/or any combination thereof. As used herein, the term “determine” (and derivatives thereof) may include measure, calculate, compute, estimate, approximate, extract, generate, and/or otherwise derive, and/or any combination thereof. As used herein, the term “generate” (and derivatives thereof) may include derive, construct, compile, create, produce, form, build, and/or any combination thereof. As used herein, the term “extract” (and derivatives thereof) may include obtain, determine, select, derive, gather, glean, distill, infer, deduce, and/or conclude, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured to extract semantic information from documents, in accordance with one or more implementations.

FIG. 2 illustrates a method to train a model to extract semantic information from documents, in accordance with one or more implementations.

FIG. 3 illustrates a method to extract semantic information from documents.

FIG. 4 illustrates an exemplary document, in accordance with one or more implementations.

FIG. 5 illustrates an exemplary dataflow of individual sequences of text through a retriever model and an extraction model as may be used in a system configured to extract semantic information from documents.

FIG. 6 illustrates an exemplary dataflow of individual sequences of text through an extraction model as may be used in a system configured to extract semantic information from documents.

### DETAILED DESCRIPTION

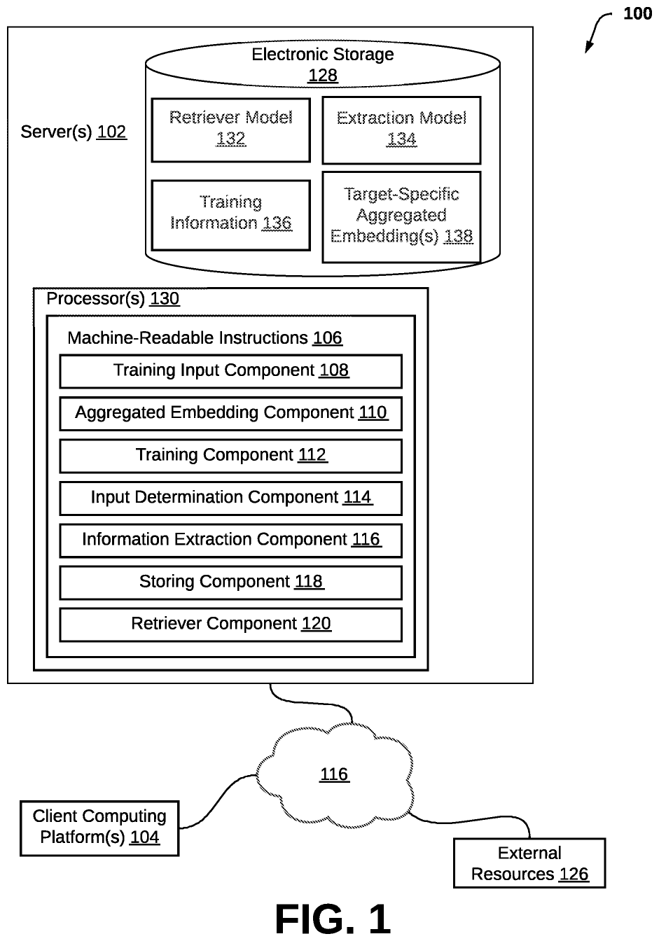

FIG. 1 illustrates a system 100 configured to train a model to extract semantic information from documents. Individual ones of the documents may include one or more segments. An individual segment may include a sequence of text and/or other information. The sequence of text may include one or more character strings arranged in a particular order. By way of non-limiting example, the document may be stored in one or more of a .PDF, .DOC, .XLS, .HTML, .PNG, .JPG, .TIF, and/or other file formats. By way of non-limiting example, an individual document may include one or more individual pages. Individual ones of the segments included in the individual document may be located on individual pages. One or more of the segments may be located on an individual page. An individual document may be an electronic representation (such as, e.g., a scan) of a physical document and/or an electronic document. By way of non-limiting example, an individual document may be an electronic representation of a tax document, a financial document, a bank statement, a medical document, an identification document, a vehicle document, an academic document, and/or another type of document.

In some implementations, system 100 may include one or more servers 102, one or more client computing platforms 104, external resources 126, and/or other components. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106. Machine-readable instructions 106 may include one or more instruction components. The instruction components may include computer program components. The instruction components may include one or more of training input component 108, aggregated embedding component 110, training component 112, input determination component 114, information extraction component 116, storing component 118, retriever component 120, and/or other instruction components.

In some implementations, system 100 may include non-transitory electronic storage 128. Storing component 118 may be configured to store and/or retrieve training information 136 in and/or from non-transitory electronic storage 128. Training information 136 may include training documents and target labels. An individual training document may include one or more training segments. Individual target labels may indicate individual training segments that are pertinent to individual targets. An individual target may include one or more character strings expressing particular information to be extracted from documents.

By way of non-limiting example, training information 136 may include a first training document and a first target label. The first training document may include a first training segment. The first training segment may be pertinent to a first target. The first target label may indicate the first training segment. By way of non-limiting example, the first target may include “governing law.” The first training segment may be pertinent to “governing law” by virtue of including a character string of “governing law,” a character string of “choice of law,” and/or another character string related to “governing law.”

In some implementations, training documents may be artificially generated by one or more machine learning algorithms, generated by the user, and/or obtained using other methods. Training information 136 may include 10s, or 100s, or 1000s of training documents. Individual documents may include one, two, three, four, five, ten, or any other number of pages. Individual documents may include one, two, three, four, five, ten, or any other number of segments. By way of non-limiting example, segments may include a paragraph, a photograph with and/or without a caption, a header, a footer, and/or other portions of documents. Individual segments may include one or more individual sequences of text.

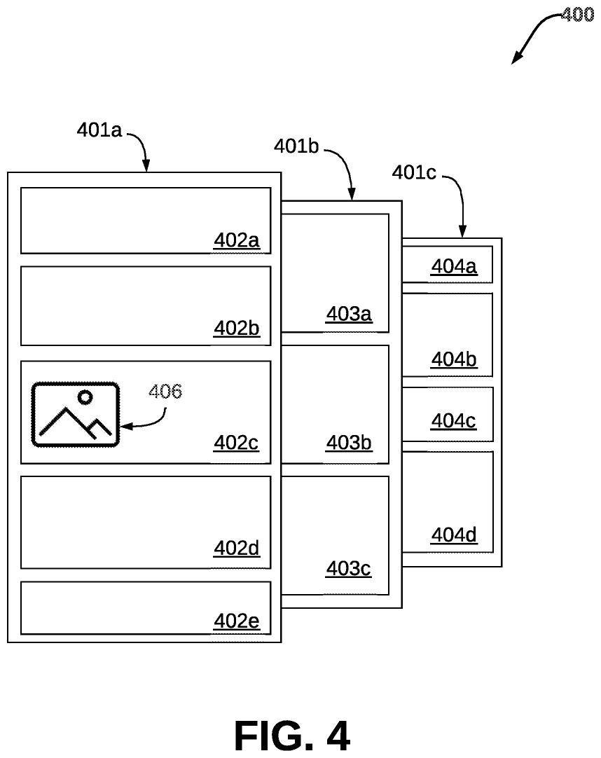

By way of non-limiting example, FIG. 4 illustrates a document 400. Document 400 may include pages 401a-401c. Page 401a may include segments 402a-402e. Segment 402c may include an image 406. Page 401b may include segments 403a-403c. Page 401c may include segments 404a-404d. Segments 402a-402e, segments 403a-403c, and segments 404a-404d may include individual sequences of text.

Returning to FIG. 1, training information 136 may include one, two, three, four, five, ten, or any other number of target labels. The target labels may indicate that one, two, three, four, five, ten, or any other number of training segments that are pertinent to individual targets. The target labels may indicate training segments that are pertinent to one, two, three, four, five, ten, and/or any other number of individual targets. In some implementations, target labels may be in the form of one or more arrays identifying one or more training segments pertinent to one or more targets, annotations on one or more training documents, and/or another form. By way of non-limiting example, the target labels may indicate that the first segment, a fifth segment, and a tenth segment are pertinent to the first target. The target labels may indicate that the first segment, a sixth segment, and an eighth segment are pertinent to a second target. As such, the target labels may indicate the first segment may be pertinent to more than one target.

Training input component 108 may be configured to obtain individual sequences of text included in individual segments. The individual segments may be included in the training documents. In some implementations, the individual sequences of text may be obtained in and/or from electronic storage 128. In some implementations, the individual sequences of text, the individual segments, and/or the training documents may be stored in electronic storage 128 and/or with training information 136. By way of non-limiting example, a first sequence of text included in the first training segment may be obtained.

Training input component 108 may be configured to obtain labelled segments. The labelled segments may be indicated by one or more target labels. As such, individual ones of the labelled segments may be individual training segments pertinent to one or more targets. The labelled segments may comprise a subset of the training segments.

Aggregated embedding component 110 may be configured to provide the sequences of text as input to a retriever model 132. Retriever model 132 may be a trained model. Retriever model 132 may be based on a transformer architecture, a recurrent neural network architecture, a long short-term memory (LSTM) network architecture, and/or another machine learning architecture. Retriever model 132 may be configured to take as input individual sequences of text. Retriever model 132 may be configured to output embeddings representing semantic meanings of the individual sequences of text. In some implementations, retriever model 132 may generate an individual output embedding for each sequence of text input to retriever model 132.

Individual sequences of text may be divided into individual tokens. Dividing an individual sequence of text into individual tokens may be the same as or similar to tokenization. Tokenization may include separating the individual sequence of text into smaller units, or individual tokens. Tokens may comprise words, characters, sub-words, punctuation, and/or other portions of the individual sequence of text. In some implementations, particular tokens may be used to denote sentence structure and/or other information. Tokenizing an individual sequence of text may enable and/or make it easier for retriever model 132 to attribute semantic meaning to the individual sequence of text. By way of non-limiting example, the particular tokens may characterize a beginning of a sentence, an end of a sentence, padding (e.g., such that tokenization results in a particular number of tokens), an unknown character, an unknown string of characters, and/or other information. By way of non-limiting example, the sequence of text “Let's discuss embeddings” may be tokenized. Thus, the sequence of text “Let's discuss tokens and embeddings” may be divided into a sequence of individual tokens. The sequence of individual tokens may include “Let,” “',” “s,” “discuss,” “em,” “##bed,” “##ding,” and “s.” By way of non-limiting example, double hash signs (“##”) may be used to denote division of an individual word into tokens. In some implementations, the sequence of individual tokens may include one or more other tokens characterizing a beginning of a sentence, an end of a sentence, a division within a word, padding, and/or other information.

In some implementations, the sequences of text may be divided into individual tokens by retriever model 132, another model, a user, another entity, and/or another system. Determining individual output embeddings may include determining token embeddings. Determining individual output embeddings may include aggregating token embeddings pertaining to individual sequences of text. An individual token embedding may represent semantic meaning of an individual token. By way of non-limiting, the first sequence of text may be divided into a first set of tokens. Determining the first output embedding may include determining and aggregating token embeddings.

Aggregated embedding component 110 may be configured to determine and/or obtain the output embeddings from retriever model 132. Individual ones of the output embeddings may individually represent semantic meanings of one or more sequences of text included in the labelled segments. In some implementations, determining an individual output embedding may include determining token embeddings for individual tokens into which the individual sequence of text has been divided. Individual token embeddings may represent semantic meaning of individual tokens. In some implementations, determining an individual output embedding may include aggregating token embeddings into sentence embeddings and/or output embeddings. Individual sentence embeddings may represent semantic meaning of individual sentences in the individual sequence of text.

In some implementations, determining an individual output embedding may include aggregating one or more sentence embeddings. Individual ones of the output embeddings may individually represent semantic meanings of one or more sequences of text included in the labelled segments. Individual output embeddings may include numeric vectors associated with individual sequences of text. By way of non-limiting illustration, the use of numeric vectors to represent semantic meanings of sequences of text may enable one or more computer processors to compare sequences of text in accordance with semantic meanings of the sequences of text. The numeric vectors may be associated with the individual sequences in accordance with semantic meanings of the individual sequences of text. Individual numeric vectors included in individual output embeddings may be normalized. In some implementations, normalizing the individual numeric vectors may include multiplying individual numeric vectors by a factor that makes a quantity associated with the individual numeric vectors (e.g., an integral) equal to a desired value (e.g., 1). By way of non-limiting example, a first output embedding representing semantic meaning of the first sequence of text may be associated with the first target by virtue of the first training segment being pertinent to the first target. Aggregated embedding component 110 may be configured to aggregate the output embeddings associated with individual targets to determine one or more target-specific aggregated embeddings 138. Target-specific aggregated embedding(s) 138 may represent a generalized semantic context of sequences of text included in segments pertinent to individual targets. In some implementations, the output embeddings may be aggregated during, before, and/or after training of an extraction model 134. In some implementations, determining one or more target-specific aggregated embeddings 138 may include determining an average value the output embeddings associated with individual targets, clustering the output embeddings associated with the first target, and/or using another method of aggregation.

By way of non-limiting example, determining an individual target-specific aggregated embedding 138 may include averaging one or more output embeddings associated with an individual target. Averaging the one or more output embeddings may include calculating a weighted average, an unweighted average, and/or another type of average. By way of non-limiting example, determining an individual target-specific aggregated embedding 138 may include clustering one or more output embeddings associated with an individual target. Clustering the one or more output embeddings may include using centroid-based clustering, density-based clustering, distribution-based clustering, and/or another clustering algorithm or method. By way of non-limiting example, output embeddings that are associated with the first target may be aggregated to determine a first target-specific aggregated embedding. Determining the first target-specific aggregated embedding may include determining an average value of the output embeddings associated with the first target, clustering the output embeddings associated with the first target, and/or aggregating the output embeddings associated with the first target using another method. By way of non-limiting example, output embeddings that are associated with a second target may be aggregated to determine a second target-specific aggregated embedding. Determining the second target-specific aggregated embedding may include determining an average value of the output embeddings associated with the second target, clustering the output embeddings associated with the second target, and/or aggregating the output embeddings associated with the second target using another method, and so forth.

By way of non-limiting example, document 400 depicted in FIG. 4 may be a document included in training information used to train a retriever model. The retriever model may be the same as or similar to retriever model 132 depicted in FIG. 1. In some implementations, individual sequences of text included in segments 402a-402e, segments 403a-403c, and segments 404a-404d may be obtained. The individual sequences of text included in segments 403a-403c, and segments 404a-404d may be provided as input to the retriever model. In some implementations, an individual output embedding generated by the retriever model may be obtained for each of the individual sequences of text. Output embeddings generated by the retriever model representing semantic meanings of the individual sequences of text may be obtained. By way of non-limiting example, segment 402c, 402e, 403b, 403c, and 404a may be pertinent to a particular target. As such, segments 402c, 402e, 403b, 403c, and 404a may be labelled segments. In some implementations, output embeddings representing semantic meanings of individual sequences of text included in one or more of segment 402c, segment 402e, segment 403b, segment 403c, segment 404a and/or one or more other segments pertinent to the particular target included in one or more other documents may be aggregated to determine a target-specific aggregated embedding. The target-specific aggregated embedding may represent a generalized semantic context of sequences of text included in segments pertinent to the particular target. Other segments may be pertinent to other targets, and the generalized semantic context of the sequences of text in those other segments may be represented by a different target-specific aggregated embedding.

Training component 112 may be configured to train extraction model 134 using training information 136. Extraction model 134 may be a machine learning model. Extraction model 134 may be configured to extract semantic information from documents. Extraction model 134 may be based on a transformer architecture, a recurrent neural network architecture, a long short-term memory (LSTM) network architecture, and/or another machine learning architecture. In some implementations extraction model 134 and retriever model 132 may be based on the same, similar, and/or different machine learning architectures. Extraction model 134 may take as input the individual sequences of text. Extraction model 134 may output semantic information. The semantic information may be associated with one or more targets. The semantic information may be extracted from the individual sequences of text. In some implementations, the semantic information may be extracted from one or more individual sequences of text. By way of non-limiting example, the semantic information may be extracted from the first sequence of text by virtue of the first segment being pertinent to the first target.

Training extraction model 134 may include providing input to extraction model 134. The input may include one or more sequences of text included training segments. In some implementations, the one or more sequences of text may include one or more sequences of text included in the labelled segments and/or one or more sequences of text not included in the labelled segments. By way of non-limiting example, the one or more sequences of text may include all of the sequences of text included in the labelled segments and some or all of the sequences of text not included in the labelled segments.

Training extraction model 134 may include determining association of the semantic information with the one or more targets to determine a loss. In some implementations, the loss may be zero when the semantic information output by extraction model 134 is associated with one or more targets. In some implementations, the loss may be calculated using a function determining a level of association of the semantic information with the one or more targets (e.g., mean squared error, mean absolute error, hubber loss, binary cross-entropy, categorical cross-entropy, etc.). Training extraction model 134 may be done gradually, over 10s, 100s, or 1000s of training documents with corresponding target labels, and/or other information. Training component 112 may be configured to adjust weights that control operations of extraction model 134 based on a backpropagation of the loss.

Returning to FIG. 1, input determination component 114 may be configured to obtain one or more target-specific aggregated embeddings 138. Input determination component 114 may be configured to obtain a document. The document may include a set of segments. Individual segments included in the set of segments may include individual sequences of text. By way of non-limiting example, the set of segments may include the first segment.

Retriever component 120 may be configured to obtain a set of individual sequences of text included in individual segments included in the set of segments. Retriever component 120 may be configured to provide the set of individual sequences of text as input for retriever model 132. Retriever component 120 may be configured to obtain output embeddings from retriever model 132. By way of non-limiting example, a first output embedding may be obtained, a second output embedding may be obtained, and so forth. The first output embedding may represent semantic meaning of the first sequence of text.

Input determination component 114 may be configured to generate a set of targeted sequences of text. Targeted sequences of text may include individual sequences of text represented by individual ones of the output embeddings. The set of targeted sequences may be a subset of the set of individual sequences of text. The set of targeted sequences of text may include the first sequence of text by virtue of the first segment being pertinent to a first target. Generating the set of targeted sequences of text may include generating similarity values associated with individual ones of the output embeddings. In some implementations, generating the similarity values may include measuring similarity between individual ones of the output embeddings and individual ones of target-specific aggregated embedding(s) 138. By way of non-limiting example, measuring similarity between individual ones of the output embeddings may include calculating inner product, cosine similarity, Euclidean distance, Jaccard similarity, Manhattan similarity, and/or another similarity metric. The individual similarity values may denote individual levels of similarity between individual ones of the output embeddings and individual ones of one or more target-specific aggregated embedding(s) 138.

Generating the set of targeted sequences of text may include identifying one or more of the output embeddings as targeted embeddings in accordance with the similarity values. Individual targeted embeddings may be associated with individual similarity values denoting levels of similarity between the individual target embeddings and individual ones of target-specific aggregated embedding(s) 138 above a given threshold. In some implementations, an individual targeted embedding may be associated with an individual similarity value denoting one or more levels of similarity between the individual target embedding and one or more of target-specific aggregated embedding(s) 138 above a given threshold. The individual sequences of text included in the set of targeted sequences of text may be likely to be included segments pertinent to individual targets. In some implementations, likelihood of an individual sequence of text being included in an individual segment pertinent to one or more individual targets may be indicated by an individual similarity value.

Generating the set of targeted sequences of text may include identifying sequences of text represented by targeted embeddings as targeted sequences of text. Generating the set of targeted sequences of text may include including the targeted sequences of text in the set of targeted sequences of text.

Information extraction component 116 may be configured to provide the set of targeted sequences of text as input for extraction model 134. Extraction model 134 may have been trained by one or more components included in system 100. In some implementations, the set of targeted sequences of text may include fewer sequences of text than the set of individual sequences of text provided as input for retriever model 132. The set of targeted sequences of text may include ten percent, twenty-five percent, fifty percent, sixty percent, and/or any other portion of the sequences of text included in the set of individual sequences of text provided as input for the retriever model 132. As such, the input to extraction model 134 may be smaller than the input to retriever model 132. By way of non-limiting illustration, providing the set of targeted sequences of text as input to extraction model 134, as opposed to the set of sequences of text input to retriever model 132, may lower the amount of computing power and/or time required to extract information from the document. By way of non-limiting example, the one or more components that trained extraction model 134 may include training input component 108 and/or training component 112. Information extraction component 116 may be configured to obtain output semantic information from extraction model 134.

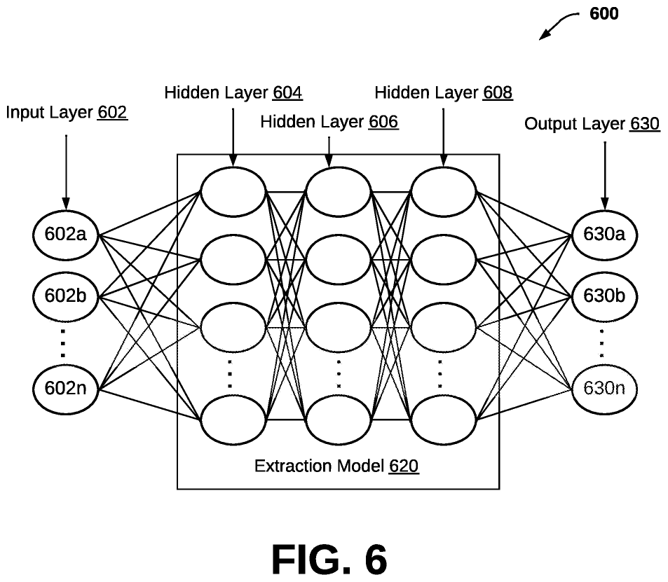

By way of non-limiting example, FIG. 6 illustrates dataflow 600 through extraction model 620. The model may be the same as or similar to retriever model 132 depicted in FIG. 1. Dataflow 600 may include an input layer 602, which may include input nodes 602a-602n. Input nodes 602a-602n may be individual sequences of text. Output layer 630 may include output nodes 630a-630n. The number of input nodes included in input layer 602 may be greater than or equal to 1. Output nodes 630a-630n may individually characterize semantic information. By way of non-limiting example, output node 630a may characterize semantic information most likely to be pertinent to one or more targets and/or most likely to be valuable information for a user of system 100 (depicted in FIG. 1). The number of output nodes included in output layer 630 may be greater than or equal to one. As depicted, retriever model 620 may include hidden layers 604, 606, and 608. The operation of retriever model 620 may be based on input layer 602 including input nodes 602a-602n of sequences of text. Hidden layers 604, 606, and 608 may include hidden nodes (depicted as ovals in FIG. 6). Hidden layer 604 may be connected to input nodes 602a-602n. Hidden layer 606 may be connected to hidden layer 604. Hidden layer 608 may be connected to hidden layer 606. Here, retriever model 620 is depicted as fully connected (with respect to hidden layers), but that is merely an example, and not intended to be limiting. The number of hidden nodes included in a hidden layer may be different for each hidden layer. In some implementations, the number of hidden nodes included in individual hidden layers may get smaller towards output layer 630. In some implementations the number of output nodes included in output layer 630 may be much smaller than the number of hidden nodes included in hidden layers 604, 606, and/or 608. The depiction of three hidden layers in retriever model 620 is merely exemplary, and any other numbers of hidden layers are considered within the scope of this disclosure.

Returning to FIG. 1, in some implementations, server(s) 102, client computing platform(s) 104, and/or external resources 126 may be operatively linked via one or more electronic communication links. For example, such electronic communication links may be established, at least in part, via one or more (electronic communication) networks 116 such as the Internet and/or other networks. It will be appreciated that this is not intended to be limiting, and that the scope of this disclosure includes implementations in which server(s) 102, client computing platform(s) 104, and/or external resources 126 may be operatively linked via some other communication media.

A given client computing platform 104 may include one or more processors configured to execute computer program components. The computer program components may be configured to enable an expert or user associated with the given client computing platform 104 to interface with system 100 and/or external resources 126, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms. By interfacing with system 100, the one or more processors configured to execute the computer program modules of the given client computing platform 104 may improve functionality of the given client computing platform 104 such that the given client computing platform 104 functions more than a generic client computing platform thereon out. Upon interfacing with system 100, a computer-automated process may be established and/or improved of the given client computing platform 104.

External resources 126 may include sources of information outside of system 100, external entities participating with system 100, and/or other resources. For example, in some implementations, external resources 126 may include one or more servers configured to provide computational resources that may be used to train extraction model 134. In some implementations, some or all of the functionality attributed herein to external resources 126 may be provided by resources included in system 100.

Server(s) 102 may include electronic storage 128, one or more processors 130, and/or other components. Server(s) 102 may include communication lines, or ports to enable the exchange of information with a network (e.g., one or more networks 116) and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 128 may include non-transitory storage media that electronically stores retriever model 132, extraction model 134, training information 136, one or more target-specific aggregated embeddings 138, and/or other information. The electronic storage media of electronic storage 128 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store training information 136, software algorithms, information determined by processor(s) 130, information received from server(s) 102, information received from client computing platform(s) 104, and/or other information that enables server(s) 102 to function as described herein.

Processor(s) 130 may be configured to provide information processing capabilities in server(s) 102. As such, processor(s) 130 may include one or more of a digital processor, an analog processor, a digital circuit designed to process information, an analog circuit designed to process information, a state machine, and/or other mechanisms for electronically processing information. These mechanisms for electronically processing information that may serve as processor(s) 130 may transform and/or improve server(s) 102 such that server(s) 102 function to accomplish a specific purpose. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute components 108, 110, 112, 114, 116, 118, 120, and/or other components. Processor(s) 130 may be configured to execute components 108, 110, 112, 114, 116, 118, 120, and/or other components by software; hardware; firmware; some combination of software, hardware, and/or firmware; and/or other mechanisms for configuring processing capabilities on processor(s) 130. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, 116, 118, and 120 are illustrated in FIG. 1 as being implemented within a single processing unit, in implementations in which processor(s) 130 includes multiple processing units, one or more of components 108, 110, 112, 114, 116, 118, and/or 120 may be implemented remotely from the other components. The description of the functionality provided by the different components 108, 110, 112, 114, 116, 118, and/or 120 described below is for illustrative purposes, and is not intended to be limiting, as any of components 108, 110, 112, 114, 116, 118, and/or 120 may provide more or less functionality than is described. For example, one or more of components 108, 110, 112, 114, 116, 118, and/or 120 may be eliminated, and some or all of its functionality may be provided by other ones of components 108, 110, 112, 114, 116, 118, and/or 120. As another example, processor(s) 130 may be configured to execute one or more additional components that may perform some or all of the functionality attributed below to one of components 108, 110, 112, 114, 116, 118, and/or 120.

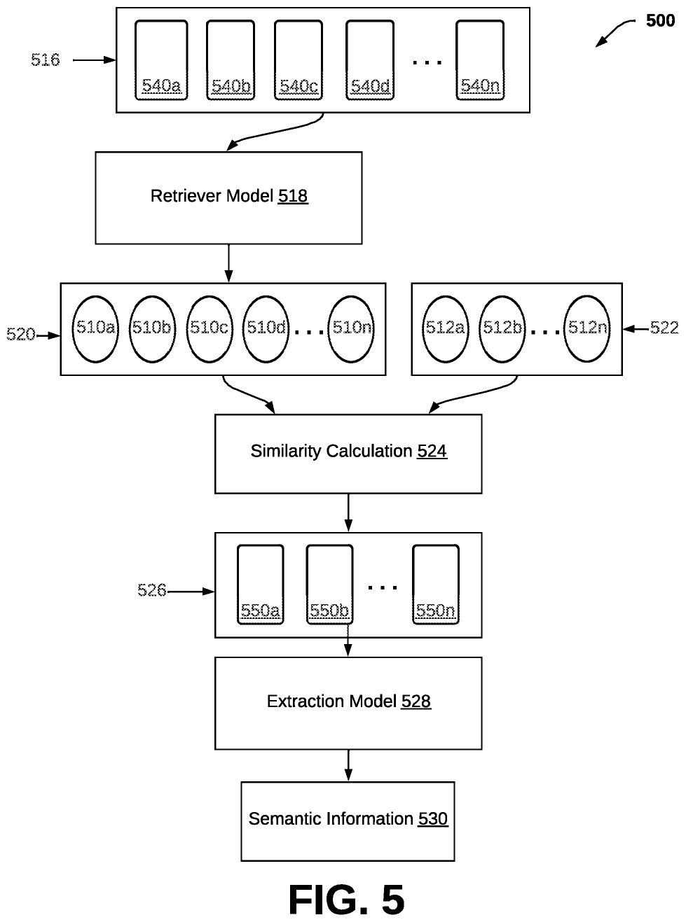

By way of non-limiting example, FIG. 5 illustrates a dataflow 500 of individual sequences of text through a retriever model 518 and an extraction model 528. Retriever model 518 may be the same as or similar to retriever model 132 depicted in FIG. 1. Extraction model 528 may be the same as or similar to extraction model 134 depicted in FIG. 1. Dataflow 500 may include input 516. Input 516 may include one or more sequences of text 540a-540n. By way of non-limiting example, sequences of text 540a-540n may be obtained from an individual document. Input 516 may be provided as input to retriever model 518. Dataflow 500 may include retriever model output 520. Retriever model output 520 may include embeddings 510a-510n individually and separately representing semantic meanings of sequences of text 540a-540n. In some implementations, there may be an equal number of sequences of text 540a-540n and embeddings 510a-510n. Retriever model 518 may output embeddings 510a-510n. Dataflow 500 may include target-specific aggregated embeddings 512a-512n. There may be any number of target-specific aggregated embeddings included in dataflow 500. Embeddings 510a-510n may be individually compared with target-specific aggregated embeddings as depicted by similarity calculation 524. Similarity calculation 524 may generate a set of target sequences of text 526 being generated. Set of targeted sequences of text 526 may include sequences of text 550a-550n. By way of non-limiting example, there may be fewer sequences of text 550a-550n than sequences of text 540a-540n. Sequences of text 550a-550n may be provided as input to extraction model 528. Extraction model 528 may output semantic information 530.

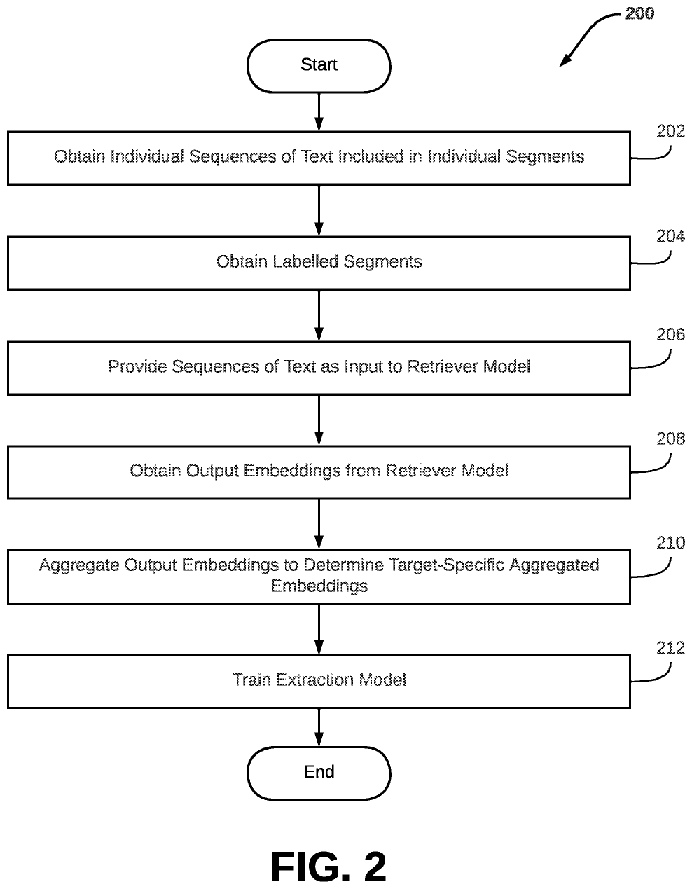

FIG. 2 illustrates a method 200 to train a model configured to extract semantic information from documents, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

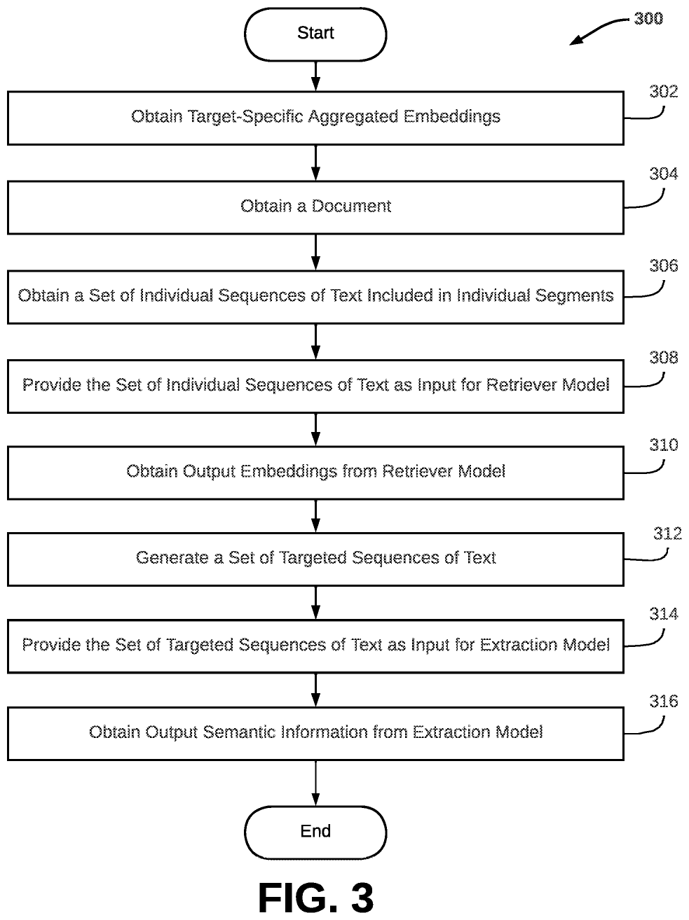

FIG. 3 illustrates a method 300 to extract semantic information from documents, in accordance with one or more implementations. The operations of method 300 presented below are intended to be illustrative. In some implementations, method 300 may be accomplished with one or more additional operations not described, and/or without one or more of the operations discussed. Additionally, the order in which the operations of method 300 are illustrated in FIG. 3 and described below is not intended to be limiting.

In some implementations, methods 200 and 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of methods 200 and 300 in response to instructions stored electronically on an electronic storage medium. The one or more processing devices may include one or more devices configured through hardware, firmware, and/or software to be specifically designed for execution of one or more of the operations of methods 200 and 300.

Regarding method 200, an operation 202 may include obtaining individual sequences of text included in individual segments. The individual segments may be included in individual training documents. The individual training documents may be included in training information. The training information may include training documents and target labels. An individual training document may include one or more training segments. Individual target labels may indicate individual training segments that are pertinent to individual targets. An individual target may include one or more character strings expressing particular information to be extracted from documents. By way of non-limiting example, the training information may include a first training document and a first target label. The first training document may include a first training segment. The first training segment may be pertinent to a first target. The first target label may indicate the first training segment. The training information may be stored in non-transitory electronic storage media. The non-transitory electronic storage media may be the same as or similar to non-transitory electronic storage 128 (shown in FIG. 1). Operation 202 may be performed by a component that is the same as or similar to training input component 108 (shown in FIG. 1), in accordance with one or more implementations.

An operation 204 may include obtaining labelled segments. The labelled segments may be indicated by one or more target labels included in the training information. The labelled segments may comprise a subset of the training segments. Operation 204 may be performed by a component that is the same as or similar to training input component 108 (shown in FIG. 1), in accordance with one or more implementations.

An operation 206 may include providing the sequences of text included in the labelled segments as input to a retriever model. The retriever model may be a trained machine learning model. The retriever model may be configured to take as input individual sequences of text. The retriever model may be configured to output embeddings representing semantic meanings of the individual sequences of text. The retriever model may be the same as or similar to retriever model 132 (shown in FIG. 1). Operation 206 may be performed by a component that is the same as or similar to aggregated embedding component 110 (shown in FIG. 1), in accordance with one or more implementations.

An operation 208 may include obtaining the output embeddings from the retriever model. Individual ones of the output embeddings may be associated with one or more individual targets. The individual ones of the output embeddings may individually represent semantic meanings of one or more sequences of text included in the labelled segments. By way of non-limiting example, a first output embedding may represent semantic meaning of the first sequence of text may be associated with the first target by virtue of the first training segment being pertinent to the first target. Operation 208 may be performed by a component that is the same as or similar to aggregated embedding component 110 (shown in FIG. 1), in accordance with one or more implementations.

An operation 210 may include aggregating the output embeddings associated with individual targets to determine target-specific aggregated embeddings. By way of non-limiting example, output embeddings that are associated with the first target may be aggregated to determine a first target-specific aggregated embedding. The target-specific aggregated embeddings may represent a generalized semantic context of sequences of text included in segments pertinent to the individual targets. Operation 210 may be performed by a component that is the same as or similar to aggregated embedding component 110 (shown in FIG. 1), in accordance with one or more implementations.

An operation 212 may include training an extraction model. The extraction model may be a machine learning model. The extraction model may take as input the individual sequences of text. The extraction model may output semantic information. The semantic information may be associated with one or more targets. The extraction model may be the same as or similar to extraction model 134 (shown in FIG. 1). Training the extraction model may include determining association of the semantic information with the one or more targets to determine a loss. Training the extraction model may include adjusting weights controlling operations of the extraction model based on a backpropagation of the loss. Operation 208 may be performed by a component that is the same as or similar to training component 112 (shown in FIG. 1), in accordance with one or more implementations.

Regarding method 300, an operation 302 may include obtaining target-specific aggregated embeddings. An individual target-specific aggregated embedding may represent a generalized semantic context of sequences of text included in segments pertinent to an individual target. In some implementations, the target-specific aggregated embeddings may have been generated during training of an extraction model. By way of non-limiting example, the target-specific aggregated embeddings may be the same as or similar to the target-specific aggregated embeddings generating method 200 (shown in FIG. 2). Operation 302 may be performed by one or more hardware processors configured by machine-readable instructions including a component that is the same as or similar to input determination component 114 (shown in FIG. 1), in accordance with one or more implementations.

An operation 304 may include obtaining a document. The document may include a set of segments. The individual segments included in the set of segments may include individual sequences of text. By way of non-limiting example, the set of segments may include a first segment. The first segment may include a first sequence of text. Operation 304 may be performed by one or more hardware processors configured by machine-readable instructions including a component that is the same as or similar to input determination component 114 (shown in FIG. 1), in accordance with one or more implementations.

An operation 306 may include obtaining a set of individual sequences of text included in individual segments included in the set of segments. Operation 306 may be performed by one or more hardware processors configured by machine-readable instructions including a component that is the same as or similar to retriever component 120 (shown in FIG. 1), in accordance with one or more implementations.

An operation 308 may include providing the set of individual sequences of text as input for a retriever model. The retriever model may be a trained machine learning model. The retriever model may be configured to take as input individual sequences of text. The retriever model may be configured to output embeddings representing semantic meanings of the individual sequences of text. The retriever model may be the same as or similar to retriever model 132 (shown in FIG. 1). Operation 308 may be performed by one or more hardware processors configured by machine-readable instructions including a component that is the same as or similar to retriever component 120 (shown in FIG. 1), in accordance with one or more implementations.

An operation 310 may include obtaining the output embeddings from the retriever model. By way of non-limiting example, a first output embedding representing semantic meaning of the first sequence of text may be obtained. Operation 310 may be performed by one or more hardware processors configured by machine-readable instructions including a component that is the same as or similar to retriever component 120 (shown in FIG. 1), in accordance with one or more implementations.

An operation 312 may include generating a set of targeted sequences of text. Targeted sequences of text may include individual sequences of text represented by individual ones of the output embeddings. The set of targeted sequences of text may be a subset of the set of individual sequences of text. By way of non-limiting example, the set of targeted sequences of text may include the first sequence of text by virtue of the first segment being pertinent to a first target. Generating the set of targeted sequences of text may include generating similarity values associated with individual one of the output embeddings. Generating the similarity values may include measuring similarity between individual ones of the output embeddings and individual ones of the target-specific aggregated embeddings. In some implementations, individual similarity values may denote individual levels of similarity between individual ones of the output embeddings and individual ones of the target-specific aggregated embeddings.

Generating the set of targeted sequences of text may include identifying one or more of the output embeddings as targeted embeddings in accordance with the similarity values. Individual target embeddings may be associated with individual similarity values denoting levels of similarity between the individual target embeddings and individual ones of the target-specific aggregated embeddings above a given threshold. Generating the set of targeted sequences of text may include identifying sequences of text represented by target embeddings as targeted sequences of text. Generating the set of targeted sequences of text may include including the targeted sequences of text in the set of targeted sequences of text. Operation 312 may be performed by one or more hardware processors configured by machine-readable instructions including a component that is the same as or similar to input determination component 114 (shown in FIG. 1), in accordance with one or more implementations.

Operation 314 may include providing the set of targeted sequences of text as input for the extraction model. The extraction model may have been trained. The extraction model may be configured to extract semantic information from documents. The extraction model may be configured to take as input individual sequences of text. The extraction model may be configured to output semantic information. The semantic information may be associated with one or more targets. The semantic information may be extracted from the individual sequences of text. Operation 314 may be performed by one or more hardware processors configured by machine-readable instructions including a component that is the same as or similar to information extraction component 116 (shown in FIG. 1), in accordance with one or more implementations.

Operation 316 may include obtaining the output semantic information from the extraction model. Operation 316 may be performed by one or more hardware processors configured by machine-readable instructions including a component that is the same as or similar to information extraction component 116 (shown in FIG. 1), in accordance with one or more implementations.

Though the present technology has been described in detail for the purpose of illustration based on what is currently considered to be the most practical and preferred implementations, such detail is solely for that purpose and that the technology is not limited to the disclosed implementations, but, instead, is intended to cover modifications and equivalent arrangements within the spirit and scope of the appended claims. For example, it is to be understood that the present technology contemplates that, to the extent possible, one or more features of any implementation can be combined with one or more features of any other implementation.

What is claimed is:

1. A system configured to train a model to extract semantic information from documents, wherein individual ones of the documents include one or more segments, wherein an individual segment includes a sequence of text, wherein the sequence of text includes one or more character strings arranged in a particular order, the system comprising:
non-transitory electronic storage media configured to store training information, wherein the training information includes training documents and target labels, wherein an individual training document includes one or more training segments, wherein individual target labels indicate individual training segments that are pertinent to individual targets, wherein an individual target includes one or more character strings expressing particular information to be extracted from documents, wherein the training information includes a first training document and a first target label, wherein the first training document includes a first training segment, wherein the first training segment is pertinent to a first target, wherein the first target label indicates the first training segment;
one or more hardware processors configured by machine-readable instructions to:
obtain individual sequences of text included in individual segments, such that a first sequence of text included in the first training segment is obtained;
obtain labelled segments, wherein the labelled segments are indicated by one or more target labels, wherein the labelled segments comprise a subset of the training segments;
provide the sequences of text included in the labelled segments as input to a retriever model, wherein the retriever model is a trained model configured to take as input individual sequences of text and to output embeddings representing semantic meanings of the individual sequences of text;
obtain the output embeddings from the retriever model, wherein individual ones of the output embeddings are associated with one or more individual targets, wherein the individual ones of the output embeddings individually represent semantic meanings of one or more sequences of text included in the labelled segments, such that a first output embedding representing semantic meaning of the first sequence of text is associated with the first target by virtue of the first training segment being pertinent to the first target;
aggregate the output embeddings associated with individual targets to determine target-specific aggregated embeddings, such that output embeddings that are associated with the first target are aggregated to determine a first target-specific aggregated embedding, wherein the target-specific aggregated embeddings represent a generalized semantic context of sequences of text included in segments pertinent to the individual targets; and
train an extraction model configured to extract semantic information from documents, wherein the extraction model takes as input the individual sequences of text and outputs semantic information, wherein the semantic information is associated with one or more targets, wherein the semantic information is extracted from the individual sequences of text, and wherein training the extraction model includes:
(a) determining association of the semantic information with the one or more targets to determine a loss, and
(b) adjusting weights controlling operations of the extraction model based on a backpropagation of the loss.

2. The system of claim 1, wherein individual output embeddings include numeric vectors associated with individual sequences of text, wherein the numeric vectors are associated with the individual sequences in accordance with semantic meanings of the individual sequences of text.

3. The system of claim 2, wherein individual numeric vectors included in individual output embeddings are normalized.

4. The system of claim 1, wherein individual sequences of text are divided into individual tokens, wherein determining individual output embeddings includes determining token embeddings and aggregating token embeddings pertaining to individual sequences of text, wherein an individual token embedding represents semantic meaning of an individual token, wherein the first sequence of text is divided into a first set of tokens, wherein determining the first output embedding includes determining token embeddings and aggregating token embeddings pertaining to the first sequence of text.

5. The system of claim 1, wherein determining target-specific aggregated embeddings includes determining an average value of the output embeddings associated with individual targets and/or clustering the output embeddings associated with individual targets, wherein determining the first target-specific aggregated embedding includes determining an average value of the output embeddings associated with the first target and/or clustering the output embeddings associated with the first target.

6. A method of training a model to extract semantic information from documents, wherein individual ones of the documents include one or more segments, wherein an individual segment includes a sequence of text, wherein the sequence of text includes one or more character strings arranged in a particular order, the method comprising:
obtaining individual sequences of text included in individual segments, such that a first sequence of text included in a first training segment is obtained, wherein the individual segments are included in individual training documents included in training information, the training information including:
training documents and target labels, wherein an individual training document includes one or more training segments, wherein individual target labels indicate individual training segments that are pertinent to individual targets, wherein an individual target includes one or more character strings expressing particular information to be extracted from documents, wherein the training information includes a first training document and a first target label, wherein the first training document includes the first training segment, wherein the first training segment is pertinent to a first target, wherein the first target label indicates the first training segment;
obtaining labelled segments, wherein the labelled segments are indicated by one or more target labels included in the training information, wherein the labelled segments comprise a subset of the training segments;
providing the sequences of text included in the labelled segments as input to a retriever model, wherein the retriever model is a trained model configured to take as input individual sequences of text and to output embeddings representing semantic meanings of the individual sequences of text;
obtaining the output embeddings from the retriever model, wherein individual ones of the output embeddings are associated with one or more individual targets, wherein the individual ones of the output embeddings individually represent semantic meanings of one or more sequences of text included in the labelled segments, such that a first output embedding representing semantic meaning of the first sequence of text is associated with the first target by virtue of the first training segment being pertinent to the first target;
aggregating the output embeddings associated with individual targets to determine target-specific aggregated embeddings, such that output embeddings that are associated with the first target are aggregated to determine a first target-specific aggregated embedding, wherein the target-specific aggregated embeddings represent a generalized semantic context of sequences of text included in segments pertinent to the individual targets; and
training an extraction model configured to extract semantic information from documents, wherein the extraction model takes as input the individual sequences of text and outputs semantic information, wherein the semantic information is associated with one or more targets, wherein the semantic information is extracted from the individual sequences of text, and wherein training the extraction model includes:
(a) determining association of the semantic information with the one or more targets to determine a loss, and
(b) adjusting weights controlling operations of the extraction model based on a backpropagation of the loss.

7. The method of claim 6, wherein individual output embeddings include numeric vectors associated with individual sequences of text, wherein the numeric vectors are associated with the individual sequences in accordance with semantic meanings of the individual sequences of text.

8. The method of claim 7, wherein individual numeric vectors included in individual output embeddings are normalized.

9. The method of claim 6, wherein individual sequences of text are divided into individual tokens, wherein determining individual output embeddings includes determining token embeddings and aggregating token embeddings pertaining to individual sequences of text, wherein an individual token embedding represents semantic meaning of an individual token, wherein the first sequence of text is divided into a first set of tokens, wherein determining the first output embedding includes determining token embeddings and aggregating token embeddings pertaining to the first sequence of text.

10. The method of claim 6, wherein determining target-specific aggregated embeddings includes determining an average value of the output embeddings associated with individual targets and/or clustering the output embeddings associated with individual targets, wherein determining the first target-specific aggregated embedding includes determining an average value of the output embeddings associated with the first target and/or clustering the output embeddings associated with the first target.

11. A system configured to extract semantic information from documents, wherein individual ones of the documents include one or more segments, wherein an individual segment includes a sequence of text, wherein the sequence of text includes one or more character strings arranged in a particular order, the system comprising:
one or more hardware processors configured by machine-readable instructions to:
obtain target-specific aggregated embeddings, wherein an individual target-specific aggregated embedding represents a generalized semantic context of sequences of text included in segments pertinent to an individual target, wherein an individual target includes one or more character strings expressing particular information to be extracted from documents, wherein the target-specific aggregated embeddings are generated during training of an extraction model;
obtain a document, wherein the document includes a set of segments, wherein individual segments included in the set of segments include individual sequences of text, wherein the set of segments includes a first segment, wherein the first segment includes a first sequence of text;
obtain a set of individual sequences of text included in individual segments included in the set of segments;
provide the set of individual sequences of text as input for a retriever model, wherein the retriever model is a trained model configured to take as input individual sequences of text and to output embeddings representing semantic meanings of the individual sequences of text;
obtain the output embeddings from the retriever model, wherein a first output embedding representing semantic meaning of the first sequence of text is obtained;
generate a set of targeted sequences of text, wherein targeted sequences of text include individual sequences of text represented by individual ones of the output embeddings, wherein the set of targeted sequences of text is a subset of the set of individual sequences of text, wherein the set of targeted sequences of text includes the first sequence of text by virtue of the first segment being pertinent to a first target, wherein generating the set of targeted sequences of text includes:
(a) generating similarity values associated with individual ones of the output embeddings, wherein generating the similarity values includes measuring similarity between individual ones of the output embeddings and individual ones of the target-specific aggregated embeddings, such that individual similarity values denote individual levels of similarity between individual ones of the output embeddings and individual ones of the target-specific aggregated embeddings,
(b) identifying one or more of the output embeddings as targeted embeddings in accordance with the similarity values, wherein individual target embeddings are associated with individual similarity values denoting levels of similarity between the individual target embeddings and individual ones of the target-specific aggregated embeddings above a given threshold,
(c) identifying sequences of text represented by targeted embeddings as targeted sequences of text, and
(d) including the targeted sequences of text in the set of targeted sequences of text;
provide the set of targeted sequences of text as input for the extraction model, wherein the extraction model has been trained, wherein the extraction model is configured to extract semantic information from documents, wherein the extraction model takes as input individual sequences of text and outputs semantic information, wherein the semantic information is associated with one or more targets, wherein the semantic information is extracted from the individual sequences of text; and
obtain the output semantic information from the extraction model.

12. The system of claim 11, wherein individual output embeddings include numeric vectors associated with individual sequences of text, wherein the numeric vectors are associated with the individual sequences in accordance with semantic meanings of the individual sequences of text.

13. The system of claim 12, wherein measuring similarity between the individual ones of the output embeddings and the target-specific aggregated embeddings includes determining an inner product of individual ones of the output embeddings and individual target-specific aggregated embeddings, a cosine similarity of individual ones of the output embeddings and individual target-specific aggregated embeddings, and/or a distance between individual ones of the output embeddings and individual target-specific aggregated embeddings.

14. The system of claim 11, wherein the set of targeted sequences of text provided as input for the extraction model includes fewer sequences of text than the set of individual sequences of text provided as input for the retriever model.

15. The system of claim 11, wherein individual sequences of text included in the set of targeted sequences of text are likely to be included in individual segments pertinent to individual targets.

16. A method of extracting semantic information from documents, wherein individual ones of the documents include one or more segments, wherein an individual segment includes a sequence of text, wherein the sequence of text includes one or more character strings arranged in a particular order, the method comprising:
obtaining target-specific aggregated embeddings, wherein an individual target-specific aggregated embedding represents a generalized semantic context of sequences of text included in segments pertinent to an individual target, wherein an individual target includes one or more character strings expressing particular information to be extracted from documents, wherein the target-specific aggregated embeddings are generated during training of an extraction model;
obtaining a document, wherein the document includes a set of segments, wherein individual segments included in the set of segments include individual sequences of text, wherein the set of segments includes a first segment, wherein the first segment includes a first sequence of text;
obtaining a set of individual sequences of text included in individual segments included in the set of segments;
providing the set of individual sequences of text as input for a retriever model, wherein the retriever model is a trained model configured to take as input individual sequences of text and to output embeddings representing semantic meanings of the individual sequences of text;
obtaining the output embeddings from the retriever model, wherein a first output embedding representing semantic meaning of the first sequence of text is obtained;
generating a set of targeted sequences of text, wherein targeted sequences of text include individual sequences of text represented by individual ones of the output embeddings, wherein the set of targeted sequences of text is a subset of the set of individual sequences of text, wherein the set of targeted sequences of text includes the first sequence of text by virtue of the first segment being pertinent to a first target, wherein generating the set of targeted sequences of text includes:
(a) generating similarity values associated with individual ones of the output embeddings, wherein generating the similarity values includes measuring similarity between individual ones of the output embeddings and individual ones of the target-specific aggregated embeddings, such that individual similarity values denote individual levels of similarity between individual ones of the output embeddings and individual ones of the target-specific aggregated embeddings,
(b) identifying one or more of the output embeddings as targeted embeddings in accordance with the similarity values, wherein individual target embeddings are associated with individual similarity values denoting levels of similarity between the individual target embeddings and individual ones of the target-specific aggregated embeddings above a given threshold,
(c) identifying sequences of text represented by targeted embeddings as targeted sequences of text, and
(d) including the targeted sequences of text in the set of targeted sequences of text;
providing the set of targeted sequences of text as input for the extraction model, wherein the extraction model has been trained, wherein the extraction model is configured to extract semantic information from documents, wherein the extraction model takes as input individual sequences of text and outputs semantic information, wherein the semantic information is associated with one or more targets, wherein the semantic information is extracted from the individual sequences of text; and
obtaining the output semantic information from the extraction model.

17. The method of claim 16, wherein individual output embeddings include numeric vectors associated with individual sequences of text, wherein the numeric vectors are associated with the individual sequences in accordance with semantic meanings of the individual sequences of text.

18. The method of claim 17, wherein measuring similarity between the individual ones of the output embeddings and the target-specific aggregated embeddings includes determining an inner product of individual ones of the output embeddings and individual target-specific aggregated embeddings, a cosine similarity of individual ones of the output embeddings and individual target-specific aggregated embeddings, and/or a distance between individual ones of the output embeddings and individual target-specific aggregated embeddings.

19. The method of claim 16, wherein the set of targeted sequences of text provided as input for the extraction model includes fewer sequences of text than the set of individual sequences of text provided as input for the retriever model.

20. The method of claim 16, wherein individual sequences of text included in the set of targeted sequences of text are likely to be included in individual segments pertinent to individual targets.
